(19) United States
(12) Patent Application Publication
(10) Pub. No.: US 2009/0070487 A1
(43) Pub. Date: Mar. 12, 2009

(54) METHOD AND DEVICE FOR DISTRIBUTING DATA ACROSS NETWORK COMPONENTS

(76) Inventor: Coke S. Reed, Austin, TX (US)

Correspondence Address: KOESTNER BERTANI LLP, 2192 Martin St., Suite 150, Irvine, CA, 92612, US

(21) Appl. No.: 12/206,598

(22) Filed: Sep. 8, 2008

Related U.S. Application Data
(60) Provisional application No. 60/970,868, filed on Sep. 7, 2007.

(51) Int. Cl. G06F 15/173

(52) U.S. Cl. 709/238

(57) ABSTRACT

A network device and associated operating methods interface to a network. A network interface comprises a plurality of registers that receive data from a plurality of data sending devices and arrange the received data into at least a target address field and a data field, and a plurality of spreader units coupled to the register plurality that forward the data based on logic internal to the spreader units and spread the data wherein structure characteristic to the data is removed. A plurality of switches is coupled to the spreader unit plurality and forwards the data based on the target address field.

### RELATED PATENTS AND PATENT APPLICATIONS

The disclosed system and operating method are related to subject matter disclosed in the following patents and patent applications that are incorporated by reference herein in their entirety:

1. U.S. Pat. No. 5,996,020 entitled, “A Multiple Level Minimum Logic Network”, naming Coke S. Reed as inventor;

2. U.S. Pat. No. 6,289,021 entitled, “A Scaleable Low Latency Switch for Usage in an Interconnect Structure”, naming John Hesse as inventor;

3. U.S. application Ser. No. 10/887,762 filed Jul. 9, 2004 entitled “Self-Regulating Interconnect Structure”; naming Coke Reed as inventor; and

4. U.S. application Ser. No. 10/976,132 entitled, “Highly Parallel Switching Systems Utilizing Error Correction”, naming Coke S. Reed and David Murphy as inventors.

5. U.S. patent application Ser. No. 11/925,546 filed Oct. 26, 2007 entitled “Network Interface Card for Use in Parallel Computing Systems”, naming Coke S. Reed as inventor.

### BACKGROUND

Nodes of parallel computing systems are connected by an interconnect subsystem comprising a network and network interface components. In case the parallel processing elements are located in nodes (in some cases referred to as computing blades) the blades contain a network interface card (in some cases the interface is not on a separate card).

### SUMMARY

Embodiments of a network device and associated operating methods interface to a network. A network interface comprises a plurality of registers that receive data from a plurality of data sending devices and arrange the received data into at least a target address field and a data field, and a plurality of spreader units coupled to the register plurality that forward the data based on logic internal to the spreader units and spread the data wherein structure characteristic to the data is removed. A plurality of switches is coupled to the spreader unit plurality and forwards the data based on the target address field.

### BRIEF DESCRIPTION OF THE DRAWINGS

Embodiments of the illustrative systems and associated techniques relating to both structure and method of operation may be best understood by referring to the following description and accompanying drawings.

FIG. 1A is a first schematic block diagram illustrating a plurality of vortex registers positioned to send data through a collection of spreading units to a central switch including K independent N×N switches;

FIG. 1B is a second schematic block diagram illustrating a plurality of vortex registers positioned to send data through a collection of spreading units to a central switch including K independent N×N switches;

FIG. 2 is a schematic block diagram illustrating two types of packets. A first packet type contains a header field H and a payload field P. A second packet type contains a header field including a subfield H′ followed by a subfield H;

FIG. 3 is a schematic block diagram illustrating the components in FIG. 1 and also an additional component that serves as a switch for transferring incoming packets from the central switch to vortex registers;

FIG. 4 is a schematic block diagram illustrating an N² X N² network that is constructed using 2·N switches each of size N×N;

FIG. 5 is a schematic block diagram illustrating an N×N spreading unit;

FIG. 6 is a schematic block diagram illustrating an N² X N² network that is constructed using 2·N switches each of size N×N and N spreading units each of size N×N;

FIG. 7 is a schematic block diagram showing a network integrated into a system; and

FIG. 8 is a schematic block diagram illustrating a network that is capable of performing permutations of data packets and can be used in place of the spreading unit.

### DETAILED DESCRIPTION

Nodes of parallel computing and communicating systems are connected by an interconnect subsystem including a network and network interface components. Cited patent document 5 discusses a method of connecting N devices using a collection C including K independent N×N switches. One advantage of such a system is that the bisection bandwidth of such a system is K times the bandwidth of a system that used only a single N×N switch. Another advantage is that a given communication of computing node is capable of simultaneously sending up to K packets with the K packets targeted for M independent nodes where M ranges from zero to K−1. The present disclosure teaches a method of reducing congestion in such systems. The present disclosure also teaches a method of reducing congestion in larger multi-hop systems. The systems that utilize the techniques described in the present disclosure may be parallel computers, internet protocol routers, or any other systems where data is transmitted between system components.

Embodiments of a network structure comprise computing or communication nodes connected by independent parallel networks. Network congestion is reduced by using “spreaders” or “spreading units” that distribute data across the network input ports. In an example embodiment, data is transferred between registers located in the network interface hardware connecting the nodes to the network. These registers have been referred to in incorporated patent document 5 as gather-scatter registers and also as Cache-mirror networks. In the present disclosure, they will be referred to as vortex registers. In one illustrative embodiment, a vortex register will consist of a cache line including a plurality of fields. In one instance, a given field in the cache line serves as a target address, in another instance the field serves as a word of data. In this manner, a first field can serve as a portion of the header of a packet to be sent through the network system and a second field can serve as the payload that is associated with the header. The techniques described here are particularly useful when the network switches are Data Vortex® switches as described in incorporated patent documents 1, 2, and 3. Disclosed embodiments include a first case in which the network is used to interconnect N nodes using K independent parallel N×N switches and a second case where N² nodes are interconnected using 2·K·N of the N×N switches.

PART I: One Level of Spreader Units Transferring Data to Independent Networks.

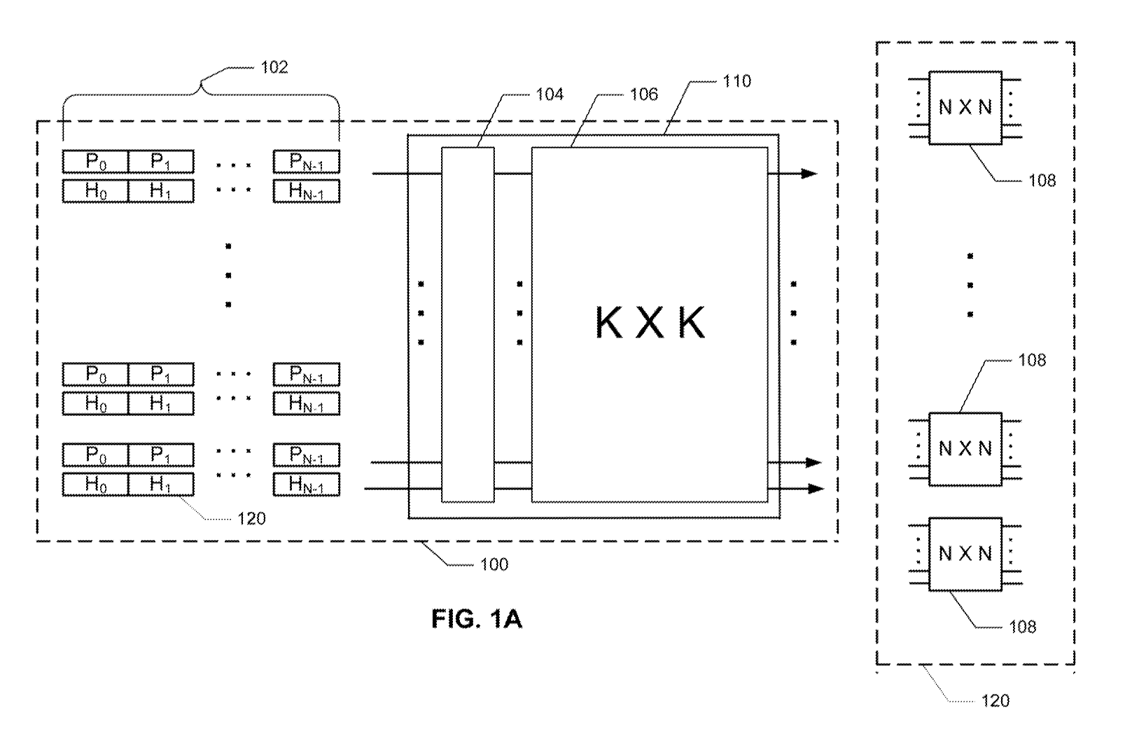

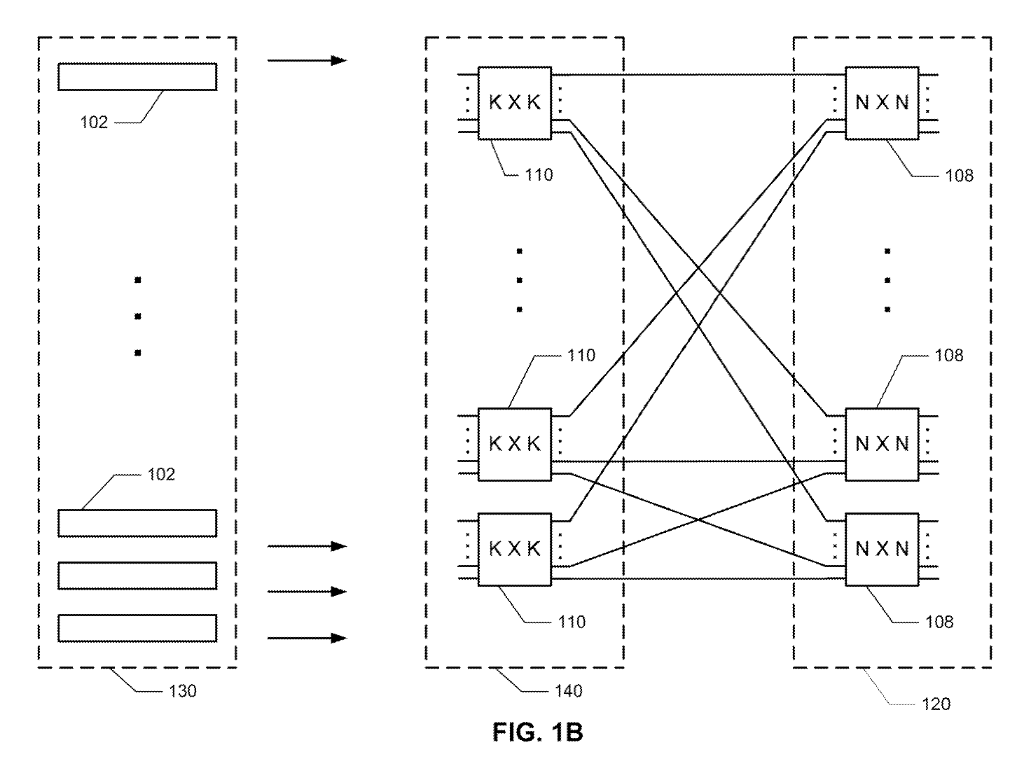

Refer to FIG. 1A and FIG. 1B illustrating a unit 100 which contains a subset of the devices on a network interface and also a plurality of switch units 108 in a central switch 120. Unit 100 contains a plurality of vortex registers 102 with each said vortex register including a plurality of fields. In the illustrative example each vortex register holds M fields with a number of the vortex register fields holding payload data P_{J} and a number of the vortex register fields holding header information H_{J}. The header information H_{J} contains the address of a field in a remote vortex register. In the systems described herein, a plurality of packets each having Payloads Pⱼ and headers containing H_{J} can be simultaneously injected into the device 104. Device 104 is capable of simultaneously accepting K packets from the vortex registers and also simultaneously forwarding K packets to the K×K switch 106. The two devices taken together form a unit 110 that will be referred to as a “spreader” or “spreading unit” in the present disclosure. Unit 104 appends the address of one of the K independent N×N switches in the central data switch to the routing header bits H_{J} of an incoming packet to form the routing header bits H_{J}H′. The said packet is then switched through switch 106 to one of the switches 108 identified by the field appended to the header by device 104. The device 106 has K output ports so that it can simultaneously send packets to each of the K independent N×N switches in the central switch 120. The switch 108 delivers the payload to the prescribed field in the target remote vortex register. In this fashion, a message packet including the contents of a plurality of vortex registers is decomposed into one or more packet payloads and sent to its destination through a number of the N×N switches 108. The spreader 110 has two functions: 1) route packets around defective network elements; and 2) distribute the incoming packets across the parallel networks in the central switch 120. In the simplest embodiment, an input port of the device 104 has a list LU of integers in the interval [0, K−1] of devices that are able to receive data from the switch 106 that receives packets from the spreading unit 104. Device 104 appends the integers in LU to incoming packets in a round robin fashion. In another embodiment, device 104 appends the integers in LU to incoming packets in a random fashion. In still other embodiments device 104 uses some deterministic algorithm to append integers in LU to incoming packets.

In a first embodiment, the list LU is updated to contain a list of links that are free of defects that are presently usable in the system. Moreover, the list is updated based on control flow information such as credit based control. In a second embodiment, flow control information is not taken into consideration in updating the list and therefore, packets may not be immediately available for sending from the spreader 110 to the central switch 120.

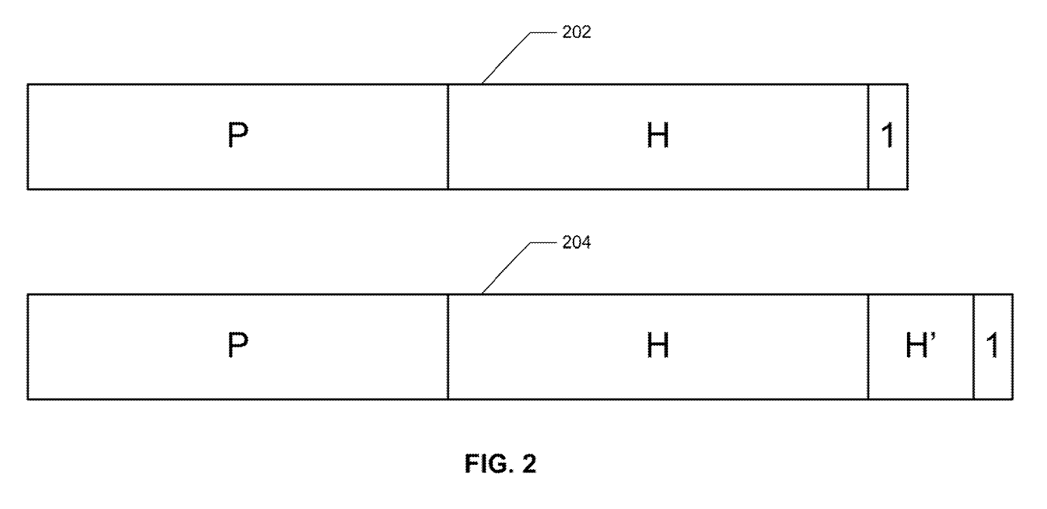

Refer to FIG. 2 illustrating a first packet 202 including a leading bit set to 1, additional header information H and a payload P. This is the form of the packet as it enters device 104. The header information H consists of various fields. In an exemplary embodiment, a first field indicates the address TN of the target node and a second field indicates the address TR of a target vortex register, a third field indicates the target field TF in the target register. In other embodiments, the header does not contain TR and TF but contains an identifier that can be used by the logic at the target node network interface to produce TR and TF. Additional header fields can be used for various purposes. FIG. 2 illustrates a packet 204 that contains four fields. The three fields illustrated in packet 202 with an additional field H′ inserted between the 1 field and the H field. The field H′ determines which of the K independent K×K switches will carry the packet. In an example embodiment, switch 106 is a Data Vortex® switch. A packet entering switch 106 is of the form of the packet 204 and the packet entering one of the switches 108 is of the form of the packet 202.

In a simple embodiment, partially illustrated in FIG. 1, there are N units 100 capable of transmitting data from the vortex registers to an attached processor (not illustrated), from the vortex registers to memory (not illustrated) and also to vortex registers on remote nodes. Each of the units 100 is connected to send data to all of the K independent N×N switches 106. Each of the K independent switches is positioned to send data to each of the N devices 100.

Consider a communication or computing system containing a plurality of nodes including the nodes N₁, N₂ and N₃. Suppose that the node N₁ sends a message M(1,3) to node N₃ and the node N₂ sends a message M(2,3) to node 3. Suppose that M(1,3) and M(2,3) will each be sent using a number of packets. In classical state-of-the art single hop systems, the network consists of a single crossbar fabric managed by an arbitration unit. Then the arbitration unit will prevent packets in the message M(1,3) from entering the crossbar fabric at the same time as packets in the message M(2,3). This is a root cause of high latencies in present systems under heavy load. In a system such as the one described in the present disclosure, this problem can be avoided by using one of the K independent N×N switches for the sending of M(1,3) and using another of the N×N switches for the sending of M(2,3). A first problem associated with this scheme is associated with the protocol requiring arbitration between N₁ and N₂. A second problem is that such a scheme may not be using all of the available bandwidth provided by the K networks.

This problem is avoided in the present disclosure by N₁ and N₂ breaking the messages M(1,3) and M(2,3) into packets and using a novel technique of spreading the packets across the network inputs. The smooth operation of the system is enhanced by the use of Data Vortex® switches in switches 106 and 108. The smooth system operation is also enhanced by enforcing a system wide protocol that limits the total number of outstanding data packet requests that a node is allowed to issue. The sending processor N₁ is able to simultaneously send packets of M(1,3) through a subset of the K switches 106. At the same time, processor N₂ is able to send packets of M(2,3) through a (probably different) subset of the K switches 106. The law of large numbers guarantees that the amount of congestion can be effectively regulated by the controlling parameters of the system wide protocols.

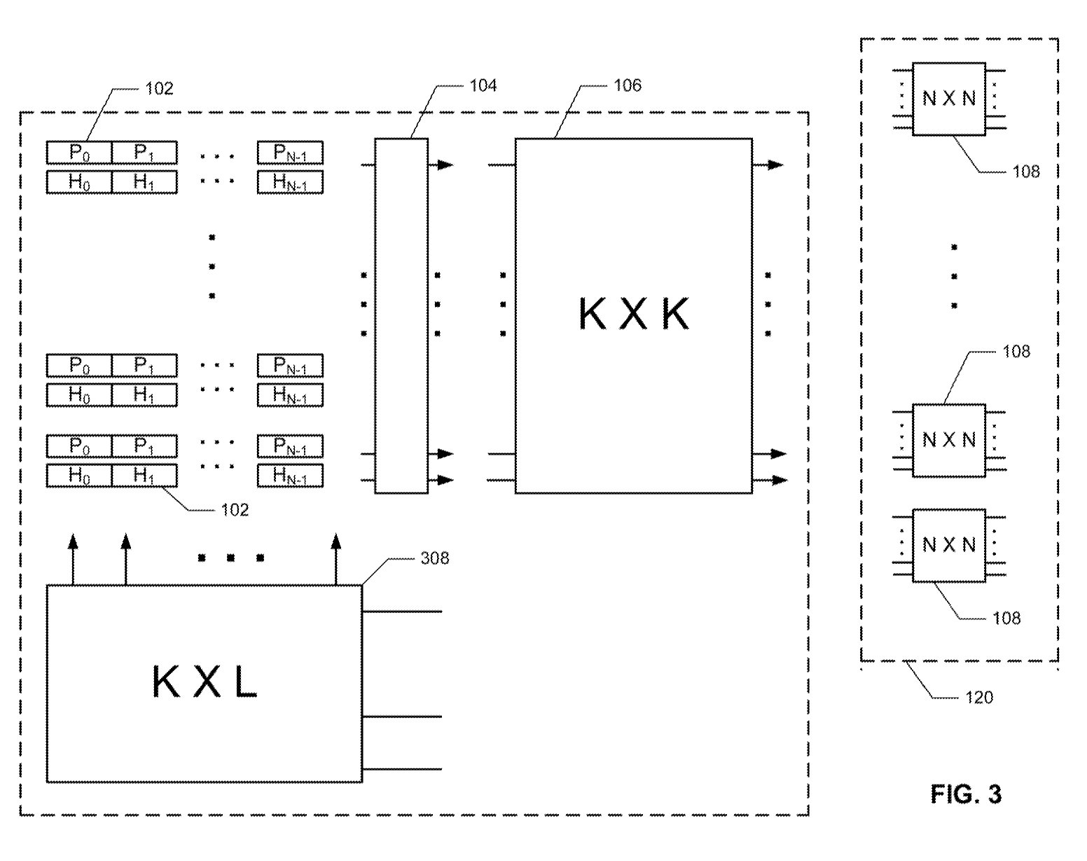

Refer to FIG. 3 that illustrates an additional input switch device 308 of the Network Interface. This device has K input ports positioned to simultaneously receive data from the K independent switches in the central switch 120. The input device can be made using a Data Vortex® switch followed by a binary tree.

Systems utilizing NIC hardware containing elements found in the devices in subsystem 100, can utilize a protocol that accesses the data arriving in a vortex register only after all of the fields in a vortex register have been updated by arriving packets. This is useful when a given vortex register is used to gather elements from a plurality of remote nodes. In case the data of a single vortex register in node N₁ is transferred to a vortex register in node N₃ (as is the case in a cache line transfer), the data may arrive in any order and the receiving vortex register serves the function of putting the data back in the same order in the receiving register as it was in the sending register.

Part II: a System with Multiple Levels of Spreaders.

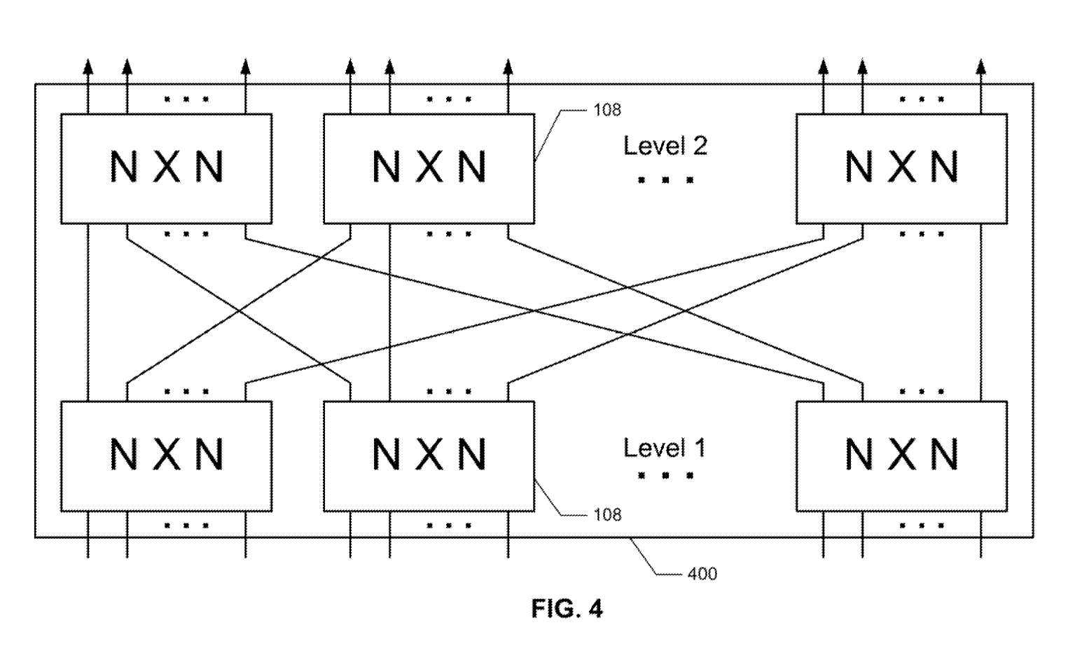

Refer to FIG. 4 illustrating an N² X N² switch 400 that is built using 2·N switches each of size N×N. N² computing or communication devices can be interconnected using such an interconnect structure. In the system considered in the present disclosure, K such systems 400 will be utilized so that the total number of N×N switches 108 that will be employed is 2·K·N. N² computation or communication units can be connected by K copies of switch 400 utilizing network interfaces with each network interface including a collection of components including the components illustrated in the network interface illustrated in FIG. 3. While network switch 400 connects all N² inputs to all N² outputs, it can suffer from congestion under heavily loaded conditions when the data transfer patterns contain certain structure. To understand this problem, suppose that a communication or computing system is constructed using N processing cabinets each containing N nodes. Suppose moreover that each processing cabinet is connected to forty level one switches. Now suppose that an application calls for a sustained high bandwidth data transfer from a sending cabinet S to a receiving cabinet R. Notice that only K of the N·K lines from switch 400 to cabinet R can be utilized in this transfer. This limitation is removed by using a spreading unit as discussed in Part I of the present disclosure.

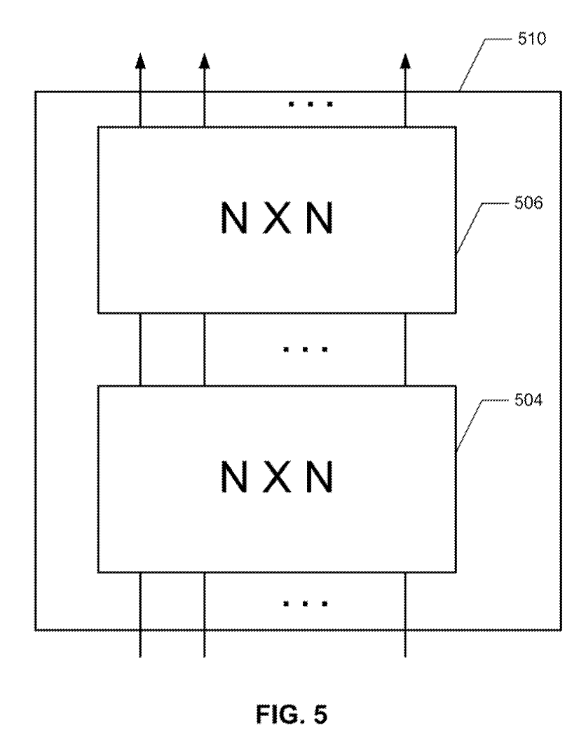

In a simple example where there is an integer B so that N=₂B, a packet entering switch 400 has a header that has a leading bit 1 indicating the presence of a packet followed by additional header information H. In one simple embodiment, the first 2·B bits of H indicate the target node address. Additional bits of H carry other information. Refer to FIG. 5 illustrating an N×N spreading unit. In a simple embodiment, a packet entering spreader 510 has a header of the same format as a packet entering switch 400. Spreading unit 504 appends a B long word H′ between the leading 1 bit and H as illustrated in packet format 204 of FIG. 2 to each entering packet.

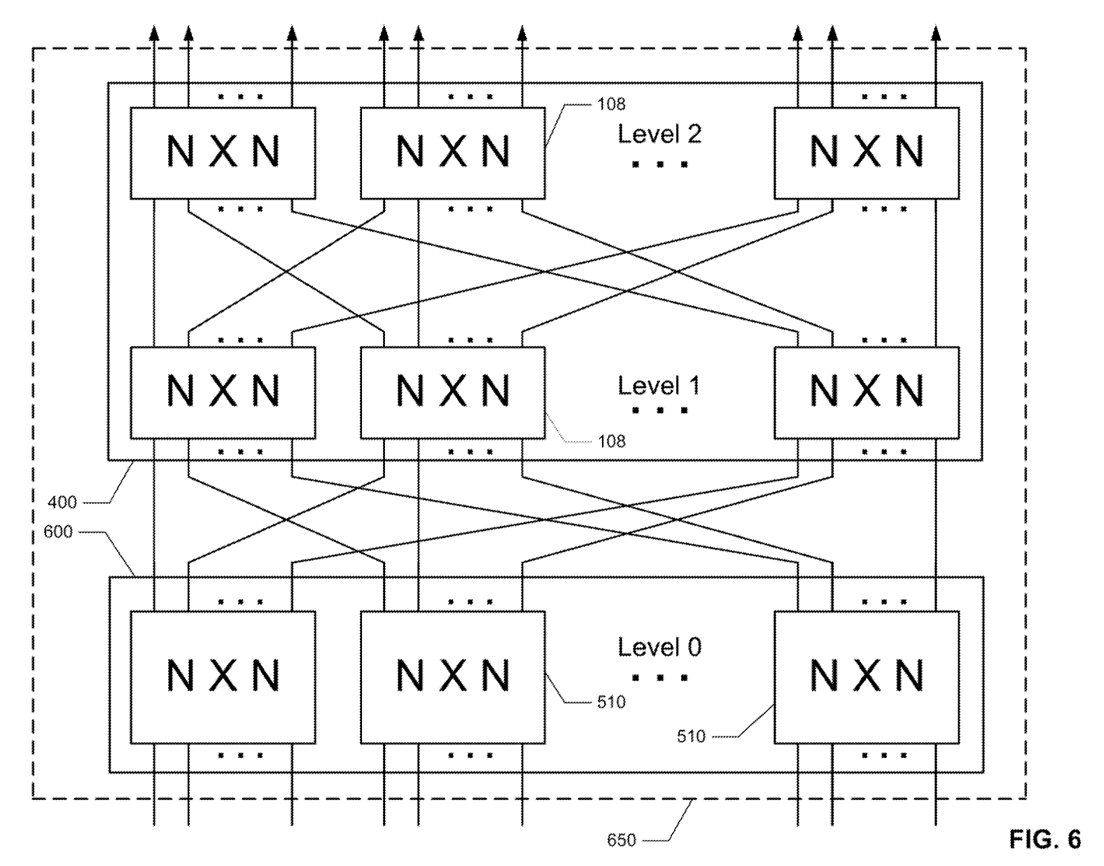

Referring to FIG. 6, packets entering unit 510 have the additional header bits appended and are routed to an input port to one of the level one switches in unit 400. In this manner, the structure is removed from the collection of packets entering unit 400 thereby greatly reducing latency and increasing bandwidth through the system in those cases where heavily loaded structured data limited performance for systems without spreader units.

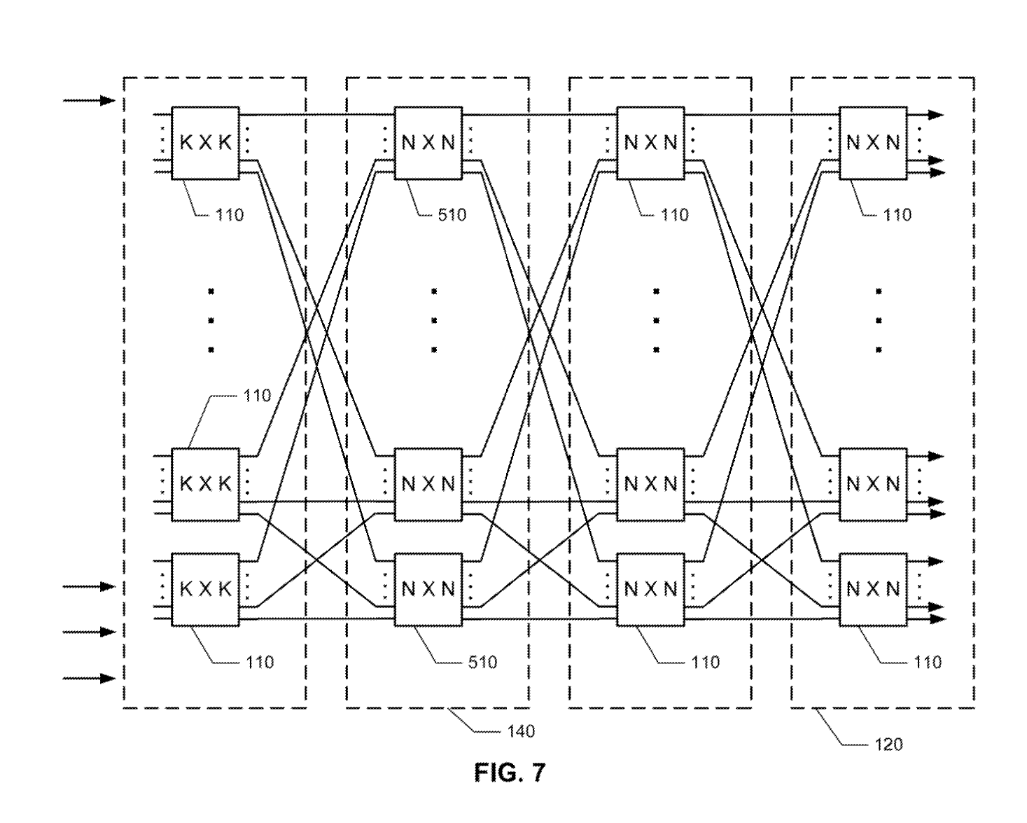

Refer to FIG. 7 that illustrates the system in FIG. 6 integrated into a system. Packets from the vortex register 102 fields 120 are sent to first level K×K spreader units 110. There are N² such units so that there are K·N² total output ports. These spreader units 110 distribute the data across the K independent networks 650. The input ports of the spreader units 501 receive the data from the outputs of the K spreader units 110. There is a total of K·N² total input ports to receive data into the spreader units 501. The spreader units receive data and spread it across the first level of switches 110. The first level switches 110 send their output to the second level of switches 110. These switches forward the data to the proper target field in the target vortex register.

In both FIG. 1B and FIG. 7, the spreading units receive data from sending devices and spread this data out across the input nodes of the switching nodes 110. This spreading out of the data has the effect of removing “structure”. The effect of removing the structure is to increase the bandwidth and lower the latency of systems that are heavily loaded with structured data.

An aspect of some embodiments of the disclosed system is that data is sent from data sending devices through “spreaders” to be spread across the input nodes of switching devices. The spreading units forward the data based on logic internal to the spreading unit. The switching devices forward the data based on data target information. Data transferred from a sending vortex register to a receiving vortex register is broken up into fields and sent as independent packets through different paths in the network. The different paths are the result of the spreading out of the data by the spreader units.

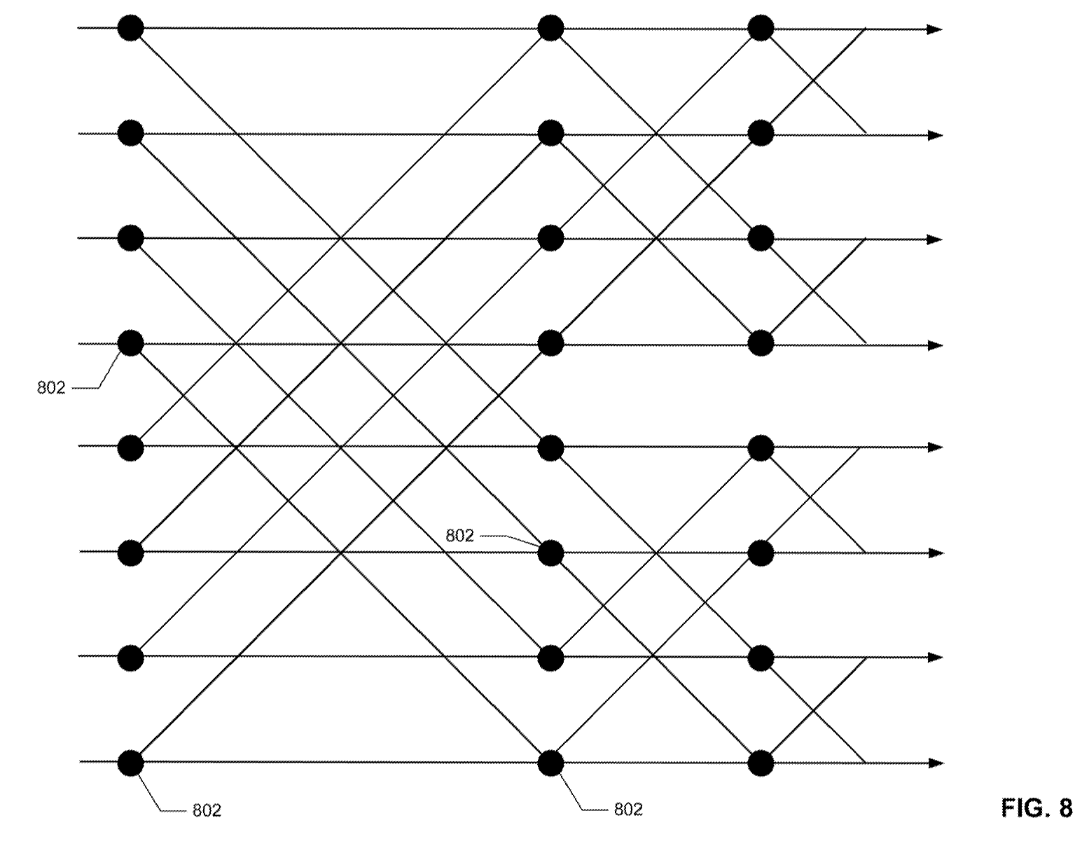

Refer to FIG. 8 illustrating a network that is capable of performing permutations of data packets and can be used in place of the spreading unit described herein provided that the list LU always includes the full set of targets. A network of the type illustrated in FIG. 8 that permutes 2^{N} inputs consists of N columns each with N elements. The example network illustrated in FIG. 8 contains 3 columns of nodes 802 with each column containing eight nodes. The nodes in FIG. 8 naturally come in pairs that swap one significant bit of the target output. For example, in the leftmost column nodes at height (0,0,0) and (1,0,0) form a pair that switch one bit. In the middle column, nodes at height (1,0,0) and nodes (1,1,0) switch one bit. Therefore, there are 12 pairs of nodes in FIG. 8. As a result, there are 212 settings of the switch each of these settings accomplishes a different spreading of the data into the input ports of the device that receives data from the network of FIG. 8.

What is claimed is:

1. A network interface comprising:
a plurality of registers that receive data from a plurality of data sending devices and arrange the received data into at least a target address field and a data field;
a plurality of spreader units coupled to the register plurality that forward the data based on logic internal to the spreader units and spread the data wherein structure characteristic to the data is removed; and
a plurality of switches coupled to the spreader unit plurality that forward the data based on the target address field.

2. The interface according to claim 1 further comprising:
the plurality of registers that divides the received data into a plurality of fields, converts the data, and sends the data as independent packets through different paths through a network.

3. The interface according to claim 1 further comprising:
a plurality of computing and/or communication nodes;
a plurality of independent parallel networks connecting the plurality of nodes and comprising a plurality of input ports;
the plurality of spreader units that distribute the data across the plurality of input ports wherein network congestion is reduced.

4. The interface according to claim 1 further comprising:
the plurality of registers comprising gather-scatter registers.

5. The interface according to claim 1 further comprising:
the plurality of registers comprising cache-mirror registers.

6. The interface according to claim 1 further comprising:
the plurality of registers comprising a cache line comprising a plurality of fields including a target address field operative as a portion of a packet header, and including a data field operative as a payload associated with the packet header.

7. The interface according to claim 1 further comprising:
the plurality of registers that divides the received data into a plurality of fields, converts the data, and sends the data as independent packets through different paths through a network.

8. The interface according to claim 1 further comprising:
a plurality N nodes; and
a plurality K independent N×N switches interconnecting the N nodes.

9. The interface according to claim 1 further comprising:
a plurality N² nodes; and
a plurality 2KN independent N×N switches interconnecting the N² nodes.
